(19) United States
(12) Patent Application Publication
(10) Pub. No.: US 2014/0297550 A1
(43) Pub. Date: Oct. 2, 2014

(54) METHODS AND SYSTEMS FOR MANAGING REQUISITION AND HIRING

(71) Applicant: CORNERSTONE ONDEMAND, INC., Santa Monica, CA (US)

(72) Inventors: Adam L. Miller, Los Angeles, CA (US); Reyhan T. Jhaver, Santa Monica, CA (US); Summer K. Rogers, Los Angeles, CA (US)

(73) Assignee: CORNERSTONE ONDEMAND, INC., Santa Monica, CA (US)

(21) Appl. No.: 14/229,644

(22) Filed: Mar. 28, 2014

Related U.S. Application Data
(63) Continuation of application No. PCT/US2012/058092, filed on Sep. 28, 2012.
(60) Provisional application No. 61/541,912, filed on Sep. 30, 2011.

(51) Int. Cl. G06Q 10/10

(52) U.S. Cl. CPC G06Q 10/1053
USPC 705/321

(57) ABSTRACT

The invention provides systems and methods for managing requisition and hiring. Such systems and methods may include one or more user interfaces that may be accessible by a candidate for a position within a company, an employee of the company, and/or a human resources employee of the company. Requisition and hiring systems and methods may assist with managing the hiring process for the company. Job posting interfaces may facilitate posting jobs to one or more job boards. A candidate network may assist with collecting references and/or feedback for a job candidate, and may utilize social networks. Requisition hiring systems and methods may also assist with mapping out career paths for employees.

### CROSS-REFERENCE

This application is a continuation application of PCT Application No. PCT/US2012/058092, filed on Sep. 28, 2012, which claims priority to U.S. Provisional Patent Application Ser. No. 61/541,912, filed on Sep. 30, 2011, each of which is entirely incorporated herein by reference.

### BACKGROUND OF THE INVENTION

Traditionally, companies seeking to fill a job opening undergo a multi-step and tedious process in order to fill the job opening. For example, companies often post job openings on separate websites, and manually sift through candidates for the job openings. Oftentimes, companies will have candidates interview for the specific job openings that the candidates applied for and receive feedback from their interviewers. However, such companies conventionally do not access additional sources of information regarding the candidate that may provide valuable information about a candidate's qualifications. For example, social networking is a tool that many individuals use today, but present an untapped source of information about candidates. Managing hiring and requisition often brings up additional challenges. For example, sometimes if the job openings become filled, companies lose track of promising candidates for whom there are currently no well-matched available positions. Or talented employees within a company may have trouble mapping out future career paths within the company so end up leaving the company.

A need exists for improved requisition and hiring systems and methods which may facilitate job postings. A further need exists for managing requisition and hiring to utilize contacts within employees or common contacts of employees to provide additional information about a candidate. Additional needs exist for career path management for employees.

### SUMMARY OF THE INVENTION

Requisition and hiring systems and methods may be provided in accordance with embodiments of the invention. The requisition and hiring systems and methods may be part of human resources or management software or applications. They may assist with identifying jobs, identifying candidates, selection management, and reporting. The requisition hiring systems and methods may be used by an administrator/recruiter, applicant (external and/or internal), and/or a hiring manager.

Jobs may be identified by creating one or more job requisition with approval workflow from one or more locations within the system. This may include organizational charting, team-based approaches, succession, and/or talent search.

Candidates may be identified through automated employee referral programs. Candidates may also be identified via social recruiting, pre-screening and assessments, auto identification of qualified candidates (e.g., high volume) with matching percentages, searching internal and external candidates, and/or through a career center.

Selection management may employ job requisition templates, job requisition management, posting management, internal and external job descriptions, configurable candidate statuses, defining hiring managers, managing candidates, career site configurations, background checks, offer letter management, candidate network review, and/or email notifications.

Reporting steps may include interactive reporting, analytics and standard reports, EEO compliance, OFCCP compliance, source tracking, and/or tracking time to file/cost per hire.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a requisition and hiring system provided in accordance with an aspect of the invention.

FIG. 2 illustrates a method for managing candidate selection and hiring, in accordance with an aspect of the invention.

FIG. 3A shows an example of a job requisition creation screen in accordance with an embodiment of the invention.

FIG. 3B shows another example of a job requisition creation screen.

FIG. 4A depicts a screenshot of an example of the invention where a user can manage the posting of job requisitions.

FIG. 4B illustrates an additional screenshot of an interface where a user can manage the posting of job requisitions.

FIG. 5 depicts a user interface wherein a user can manage multiple job requisitions.

FIG. 6 provides screenshot with a list of candidates for a specific job.

FIG. 7 depicts an aspect of an embodiment of the invention wherein a screenshot of the results of a candidate search is shown.

FIG. 8 shows an example of an integration of candidate and employee social networks in accordance with an embodiment of the invention.

FIG. 9 illustrates an example of an internal employee management interface.

FIG. 10 shows an interface for managing career preferences.

### DETAILED DESCRIPTION OF THE INVENTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed in practicing the invention.

The invention provides systems and methods for managing requisition and hiring. Various aspects of the invention described herein may be applied to any of the particular applications set forth below or for any other types of human resources or management software or application. The invention may be applied as a standalone system or method, or as part of an integrated system, such as in a system for employment management, human resources, or recruiting. It shall be understood that different aspects of the invention can be appreciated individually, collectively, or in combination with each other.

A user of a requisition and hiring system may be any individual interacting or utilizing the system. A user may be affiliated with a company, or other entity, that is using the requisition and hiring system. For example, a company may utilize the system to assist with managing the company's human resources, such as identifying job openings, posting job openings, filling job openings, and/or managing existing employees. In some embodiments, the user of a system may be an employee of the company. The user may be a human resources employee of the company who may utilize the system to manage the company's human resources (e.g., identifying job openings, posting job openings, filling job openings, and/or managing existing employees), and/or participate in recruiting for the company. The user may be an employee tracking the employee's career path within the company. The user may be capable of interacting with one or more user interface of the system. The user may or may not need to be authenticated (e.g., enter password) to access the system.

Any description of a company may apply to any group, association, partnership, organization, affiliation, or entity that may employee one or more individual, or may have one or more job openings. A company may or may not have any incorporation status.

A candidate may be an individual applying for a job at the company. The candidate may be an internal candidate (e.g., already an employee of the company), or may be an external candidate (e.g., not employed by the company). A candidate may submit an application for a job opening at the company. The candidate may optionally submit information about the candidate, such as the candidate's identity, resume, references, experience, or desired job parameters. The candidate may optionally submit information relating to the candidate's social networks or contacts, which may include employees and/or contacts of the company. An applicant may be a candidate. An applicant may be any individual searching for one or more jobs, or applying to one or more job postings. An applicant may be any individual being considered for a job.

In some embodiments, a candidate may be a user of the system. A candidate may optionally use the system to search for job openings and/or apply for a job. A candidate may use the system to check on his or her job application status.

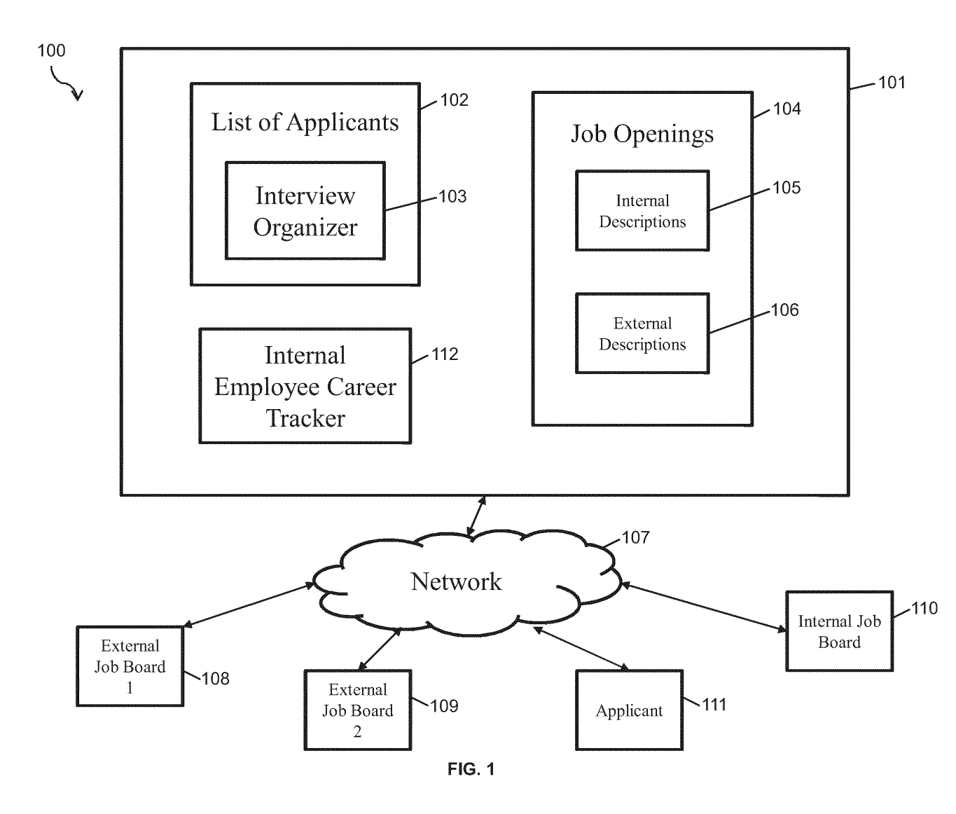

Aspects of the invention provide a system for managing requisition and hiring, as illustrated in FIG. 1. The requisition and hiring system 100 may include a manager system 101 in communication with one or more external job boards 108, 109, internal job boards 110, and/or applicants 111. The manager system may communicate with them over a network 107. The requisition and hiring system 100 and/or the manager system 101 may operate on a computer or other network device, including but not limited to a server, desktop, laptop, tablet, or mobile device (e.g. smartphone, cell phone, PDA). The description of the systems may apply to computers communicating over a network. The job boards 108, 109, 110, 111 may be displayed on a computer or any other network device such those described herein. One or more computer or other network device upon which an interface for requisition and hiring system and/or manager system 100, 101 may be displayed may communicate over a network 107 with one or more computer or other network device upon which an interface for a job board 108, 109, 110, 111 may be displayed.

As illustrated, the manager system 101 may be used for talent pooling, to manage candidates, job postings, internal employees and the hiring process. The manager system may include a list of applicants 102, job openings 104, and/or an internal employee career tracker 112.

The manager system may include one or processors that may be capable of executing one or more step. The manager system may include one or more memory units that may be capable of storing tangible computer readable media, which may comprise code, logic, and or instructions to perform one or more step. The one or more processors may be capable of executing the computer readable media. The memory units may be capable of storing data relating to the list of applicants, job openings and/or internal employee career tracker. In some embodiments, the memory units may be databases. In some embodiments, the system may have a cloud computing based infrastructure. The system may be implemented on one or more computer or other network device. The manager system may include one or more user interface that may enable a user of the system to interact with the system. The user interface may include one or more of a screen, touchscreen, keyboard, mouse, trackball, touchpad, joystick, motion sensor, optical sensor, audio sensor, and/or other interfacing devices. A user interface may include or utilize a display device, such as a screen, or other device capable of displaying information. A graphical user interface may be displayed on a display device. The graphical user interface may include one or more window displayed on a screen. In some embodiments, a manager system may be implemented as a website or intranet site. Controlled interaction between one or more user and the web site may be provided. Controlled interaction between hiring entity and/or human resources employee and a candidate may be provided via the website.

In some examples, the manager system 101 includes lists of applicants 102. The lists of applicants may be ranked or sorted based on qualifications. The system may further allow users to manage candidate's interview schedules and receive feedback from current employees. In some embodiments, the list of applicants may include an interview organizer 103 that may assist with the schedule management and feedback.

The manager system 101 may also manage job openings or needs 104. In this feature of the system, a user may create a job opening or requisition. The job openings may include internal descriptions 105 and external descriptions 106 of a job. The internal and external descriptions may be entered and/or stored separately. In some instances, it may be desirable to post different internal and external job descriptions to applicants who may already be employees of the company, or outside the company respectively. A user may enter internal and external job descriptions so that they may vary or are the same. In one variation, a user can fill out different descriptions for the external or internal posting. For example, an internal posting may require less information about the company.

An internal employee career tracker 112 may be provided within a manager system 101. The internal employee career tracker may include feedback and/or reviews of an employee. The internal employee career tracker may also keep track of various positions that the employee has held within the company. In some embodiments, the employee career tracker may assist an employee and/or user of the system with charting or projecting a career path for the employee.

The requisition and hiring system 100 may provide an embodiment where the manager system 101 transfers information over a network 107. The communications may be over a network such as a local area network (LAN), wide area network (WAN) such as the Internet, personal area network, a telecommunications network such as a telephone network, cell phone network, mobile network, a wireless network, a data-providing network, or any other type of network. The communications may utilize wireless technology, such as Bluetooth or RTM technology. Alternatively, various communication methods may be utilized, such as a dial-up wired connection with a modem, a direct link such as TI, ISDN, or cable line. In some embodiments, a wireless connection may be using exemplary wireless networks such as cellular, satellite, or pager networks, GPRS, or a local data transport system such as Ethernet or token ring over a LAN. In some embodiments, the system may communicate wirelessly using infrared communication components.

A manager system 101 may communicate with one or more device such as a personal computer, server, laptop computer, tablet, mobile phone, cell phone, satellite phone, smartphone (e.g., iPhone, Android, Blackberry, Palm, Symbian, Windows), personal digital assistant, Bluetooth device, pager, land-line phone, or other network device may be used in order to provide communications. Such devices may be communication-enabled devices. The manager system may communicate with a cloud computing infrastructure.

Information communicated by the manager system 101 may include the external job descriptions 106 to external job boards 108-109. In one example, the manager system allows a user to specify external job boards 108-109 where the job requisition should be posted. In some examples, the user may further modify the job posting to be specific to each job board, or to a certain class or group of job boards. In other examples, the external description 106 may be copied to all outside job boards chosen by the user. Changes made to the external job board on the manager system 101 may automatically update the external job boards 108-109, or job boards the user specifies.

The requisition and hiring system 100 may also include information transmitted from the manager system 101 over the network 107 to internal job boards 110. The internal job board 110 may be on a company website, or may be an email to a set of internal employees. In some instances, the internal job board is only viewable by internal employees or someone who is authenticated by the company. The manager system 101 may update the internal job board 110 or send a second email or notice to current employees automatically when the internal job description 105 is modified, or when the user of the system 101 requests an update.

The manager system 101 may update the job boards 108-110 at certain intervals. These may be periodic time intervals, or may be event driven. The intervals may or may not be regular. The manager system may also remove job openings 104 when a user indicates the search has been closed. In some examples, the system 101 may update the job boards 108-110 when the user makes changes, in other examples, the user may set a time interval. The user may indicate a different update interval for external jobs boards 108-109 and internal job boards 110.

FIG. 1 further depicts an aspect in which a potential job applicant 111 can exchange information with the manager system 101 over the network 107. The manager system 101 may have an applicant site. In some embodiments, the applicant 111 may do at least one of the following: view job openings, access upload his or her resume, upload references and/or in company contacts, allow social network access, schedule interviews, view progress, and receive offer information. The manager system 101 may allow an applicant user 111 to manage his job search with multiple companies and/or job opportunities.

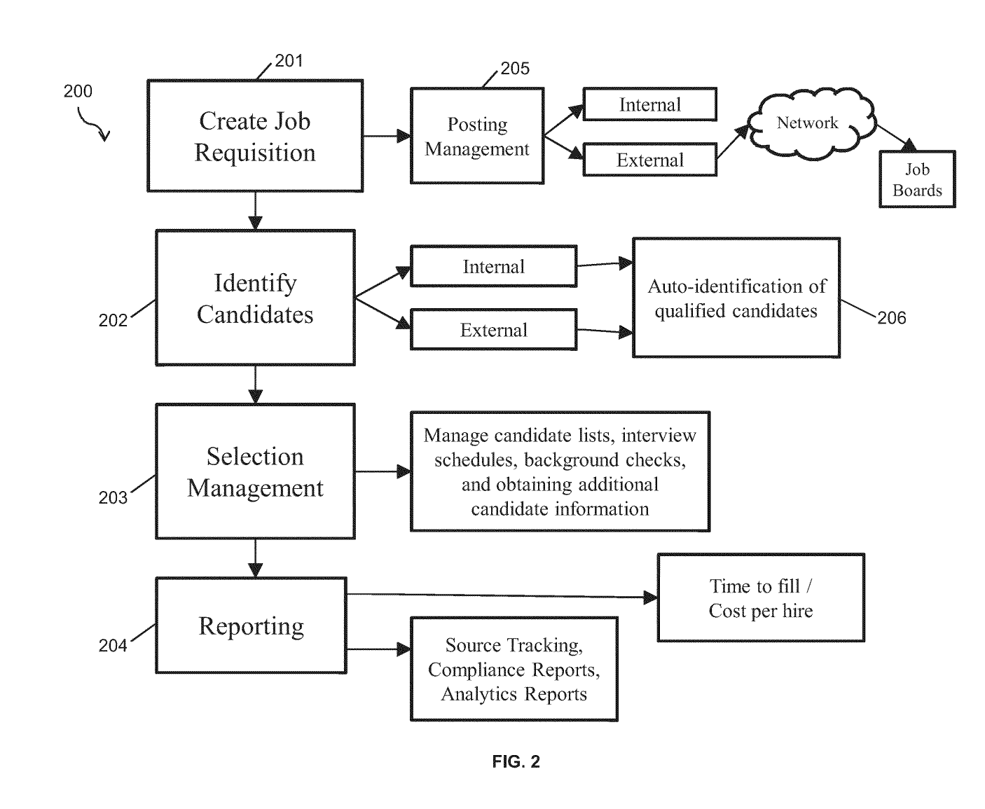

FIG. 2 describes another aspect of the invention, which comprises a method for managing candidate selection and hiring. The method may include creating a job requisition 201, identifying candidates 202, selection management 203, and reporting 204. One or more of these steps may be optional or may be provided in different orders. Additional steps may be included.

In the selection method 200, the first step may be the creation of a job requisition 201. The user may create a job requisition using templates provided by the invention. This step may include posting management 205 of the requisition. Posting management may include posting to internal and/or external job boards. Once the job requisition is created, the user may specify which internal and/or external job boards or sites it will be posted to. In some examples, the invention provides a preloaded list of sites, and the user can specify which ones the job requisition should be sent to. The user may also add an external job board to this list. In an initialization before use, the user may authorize the system to access accounts on the external job board websites, if such websites require password or other validation. The system may also automatically create accounts for the company user on external job boards, allowing the user to broadcast their job requisition to multiple websites or organizations with minimum inconvenience. The system may communicate with external job boards over a network. In some embodiments, the system may post the job requisition to internal job boards. An internal job board may be a section of an employer's website, email to a group of employees, or list serve. Job posting management may also include updating or removing job openings from internal and external job boards.

A second step shown in the method 200 of FIG. 2 may be identifying candidates 202. FIG. 2 portrays an aspect of the invention where the identification of candidates by the user may be aided by auto-identification 206. The user may identify desirable qualities, and the auto-identification 206 may give a percentage for each potential candidate, representing the candidate's “fit” with the user-identified qualities based on the candidate's resume, information obtained from the candidate by the system and/or information obtained elsewhere concerning the candidate by the system. The system may list the most desirable candidates at the top of the applicant list, accompanied by their fit percentages or scores. In some examples, the user can set different importance or weight to qualities, and the system calculates a score or percentage weighing more important qualities more heavily.

This auto-identification system may be equally applied to internal and external candidates. Alternatively, the user may specify a different set of qualities that are important or desirable for an internal candidate versus an external candidate. Thus, the score or percentage of an individual might depend on whether he is internal or external. The system may list the internal candidates separately, in their own ranking, or may list all candidates together and normalize the scores to a specific scale if needed.

A third step shown in the method 200 of FIG. 2 may be Selection Management 203. In some examples, the system provides lists of candidates that have applied for the job, which may be ranked by their auto-identification score or percentage. Candidates may also be color coded on the list. For example, higher ranked candidates may be green, medium candidates may be yellow and low candidates may be red. Alternatively, the candidates may be ranked or colored based on their progress in the hiring process—for example, whether they have submitted all the required information or whether the user is waiting on additional submissions. The candidate lists may also tell the user whether a candidate has been interviewed, will be interviewed, has been rejected or is waiting on correspondence from the firm. In some examples, the user can manipulate the list, choose a subset of candidates to perform some action on, for example send a rejection letter or send a letter asking for more information, or choose a subset of candidates to compare. The user may also be able to select the group of candidates they wish to interview, and the system may automatically begin the process of scheduling interviews.

The selection management step may include interview schedules. The system may aid in selecting interview times and interviewers, for example based on company Outlook™ calendars, and allow the user to send an automatic notification to the job candidate and the interviews. In some examples, the system may also solicit feedback from the interviewers after the interview. The system may send an email reminding the interviewer to access the system through the network and fill out a feedback form. Alternatively, the system may receive feedback from the interviewers in an email and automatically upload the feedback to the candidate's file.

The aspect of the invention may further include obtaining additional candidate information in the selection management step. This may include sending the candidate automated emails to remind them to access the system and upload information. In some examples, this includes obtaining social network information from the candidate. The system may ask the candidate for access to his or her social networks, such as LinkedIn, Facebook, Google+, MySpace, etc, and obtain a list of the candidate's connections. In other examples, the candidate may self identify connections and/or create a network within the system. If the candidate has a connection to a current employee or contact of the company, which the system can check using company records, then the system will inform the user to obtain recommendation or other information from the person. In some examples, the system also obtains access the social networks of current employees and contacts. The system may have access a database of these connections that is updated periodically, or the system itself may have permission to access the social network connections of employees. In examples where the system has access to a list of employee's social network connections, the system may compare such lists with the network connections of the candidate. By doing so, the system may find a common connection and notify the user. The user can ask the employee to request a recommendation for or information about the candidate from their common connection. Alternatively, in other examples, the system may find the common connection and automatically email the employee notifying them of it and requesting the use of their connection to obtain a recommendation concerning the candidate.

A fourth step of the method may include reporting 204. The system may track multiple job requisition processes and associated candidates. The system may aggregate this information to provide averages over all job requisition processes and statistics related to a single job requisition. For example, the system may calculate the cost per hire by using the hourly rate of employees involved in the process and the number of hires performed through the system. Further, the system may provide information about the average time to fill a job opening, the average time to fill certain categories of job openings and/or the time it took to fill a specific job opening.

The system may also track sources of candidates for job openings. For example, the system may track whether a candidate was entered into the system via an external job board, internal job board, applicant site, headhunter, recruited by human resources, or any other source. The system may track whether the candidate is already an employee of the company or external to the company. The system may also generate compliance reports which may manage candidates or employees' ongoing certifications. The system may also generate analytics reports which may monitor performances of one or more employees and/or candidates. For example, the system may track qualities of candidates that may lead to job positions filled, and associated statistics.

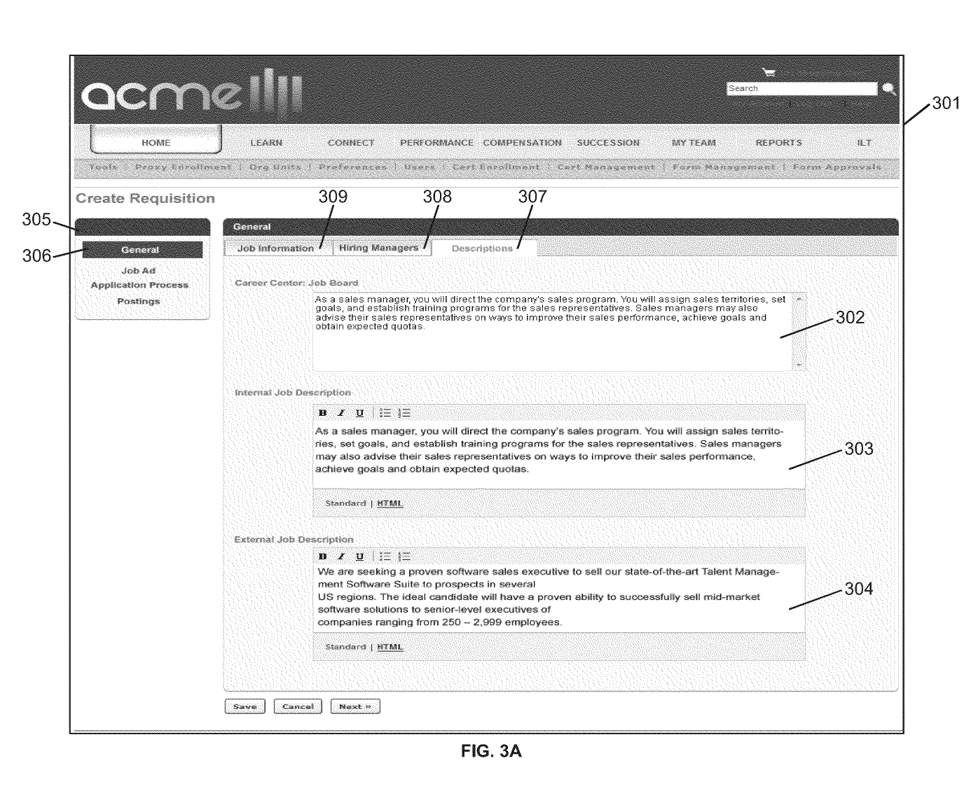

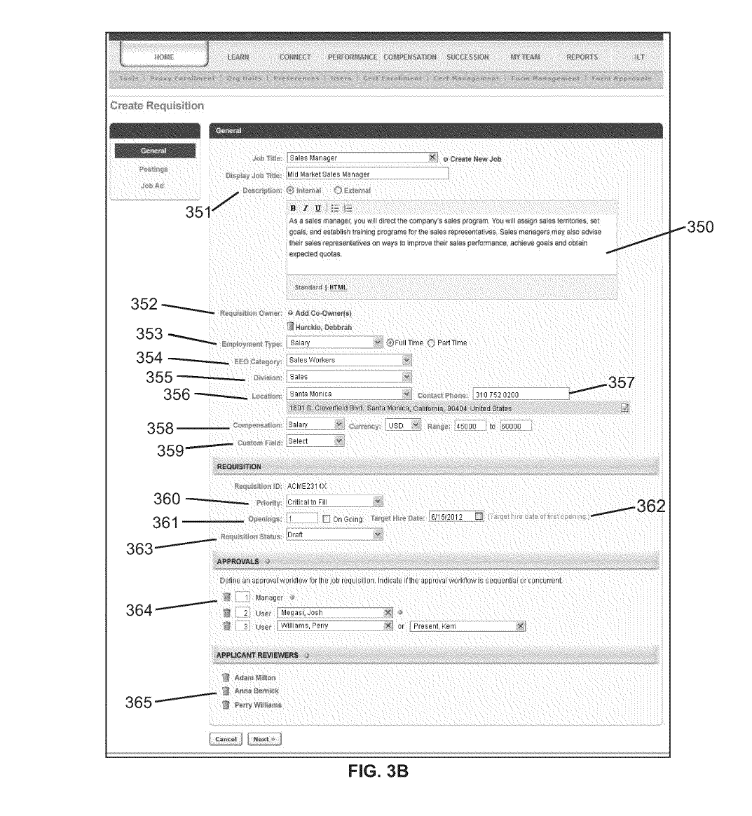

FIG. 3A shows a screenshot of an example of the invention, showing the job requisition creation screen 301. In one example, three boxes may be provided where a user can design different job descriptions for different subgroups 302-304. Any types of user interfaces may be provided in order to accept a user's job descriptions. For example, the boxes may refer to any type of graphical user interface, such as text panes, may accept images, video, or audio, or may incorporate drop-down menus, selections or job description templates. Any number of boxes may be provided, which may correspond to any different number of subgroups for job descriptions, including but not limited to one or more boxes, two or more boxes, three or more boxes, four or more boxes, five or more boxes, ten or more boxes, or twenty or more boxes. In the example shown in FIG. 3A, a first description box is for a company's Career Center 302. The Career Center may be for the applicant and/or internal employee side of the requisition and hiring system. A second description box may be for an Internal Job Description 303. The Career Center box 302 and the Internal Job Description box 303 may contain identical descriptions in this example. In other examples, the Career Center description 302 may be accessible by external as well as internal applicants, and the company may have a different description.

There may also be an External Job Description box 304. The user may choose to include different information in an External Job Description 304 than in an Internal Job Description 303 or in a description for the Career Center Job Board 302. Alternatively, the user may choose to enter the same information in the External Job Description and the Internal Job Description and/or Career Center Job Board. By having different regions of a user interface that a user may enter descriptions, the user may be able to personalize and/or target job descriptions for different subgroups.

Examples of subgroups may include employees and non-employees. Some subgroups may be based on specific job boards. Other examples of subgroups may be based on demographics, such as geographic location. In one example, an External Job Description may have more information about the company than an Internal Job Description.

In some embodiments, the regions of the user interface through which different job descriptions may be provided may be visually mapped to one another. For example, boxes may form a column and/or a row. The boxes may form an array, staggered rows, webs, or any other configuration. The boxes may all fit on the screen to be displayed simultaneously. Alternatively, they may require the user scroll, click, or otherwise manipulate the user interface when viewing the boxes. The boxes may be similarly dimensioned or visually formatted to one another, or may vary. For example, each of the boxes may or may not have substantially the same shape, size, or tools.

The boxes may include one or more editing tool that may assist the user with creating the job description. For example, the boxes may include one or more text formatting tool, such as coloring, bold, italics, underline, bullet points, outlines, font size, or any other tool commonly found in word processors. The boxes may also include graphics, video, or audio editing tools. The boxes may include one or more tools that may enable the user to visually manipulate the job description.

A user may enter different job descriptions within one screen (e.g., within a plurality of boxes), and click submit once. One or more of the job descriptions may be posted to a single board, and/or multiple boards.

FIG. 3A further depicts the process the user may be guided through during the user's requisition creation in a box on the left 305. The system highlights what step the user is on 306. Further, the step depicted in FIG. 3A has tabs 307 for the “General” section the user is currently using. The other tabs include where the user can enter Hiring Managers 308 and Job Information 309 associated with the requisition the user is creating.

FIG. 3B shows another example of a job requisition creation screen. As previously described, different job descriptions may be provided for internal and external job postings. In one example, a job requisition creation screen will include a job description box 350. In some embodiments, the job description box may be an internal job description box or an external job description box.

An indicator 351 may be provided whether the job description is for an internal or external job posting. A user may be able to select whether the job posting is an internal or external posting. A user may be able to create any number of internal job postings or external job postings. In some embodiments, both internal and external job postings may be created for a single job opening. The system may be capable of tracking multiple postings for a single opening so that if the opening is filled, all corresponding job postings may be removed or updated.

In some embodiments, a requisition owner 352 may be provided.

Additional details about the job posting may be provided, such as employment type 353, EEO category 354, division 355, location 356, contact information 357, compensation 358, or custom fields 359. The additional details may be entered using any interface tool, including but not limited to drop-down menus, buttons, selection boxes, or text fields.

Furthermore additional details about the requisition may be provided. For example, the job's priority 360 (e.g., critical to fill, less critical to fill, not critical to fill), number of openings 361, target hire date 362, and/or requisition status 363 may be inputted.

One or more approvals may be provided for the job requisition form. An approval may include an approval workflow 364 for a job requisition. One, two, three, or more individuals may be selected for an approval workflow. In some embodiments, the approval workflow may be sequential or may be concurrent. In some instances, alternative individuals may be selectable during an approval workflow, while certain individuals may be mandatory during the approval workflow.

One or more applicant reviewers 365 may be displayed on the job requisition form. Any number of applicant reviewers may be added to the job requisition form. A user may click on or otherwise select an applicant reviewer name. Additional information about the applicant reviewer may be displayed when the applicant reviewer name is selected.

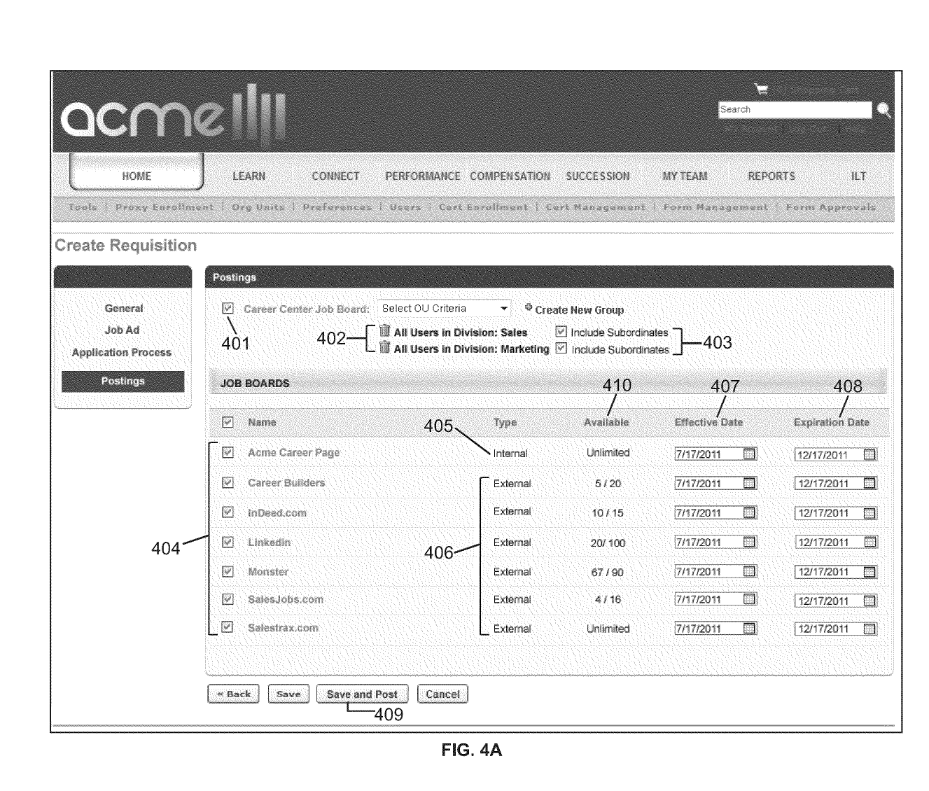

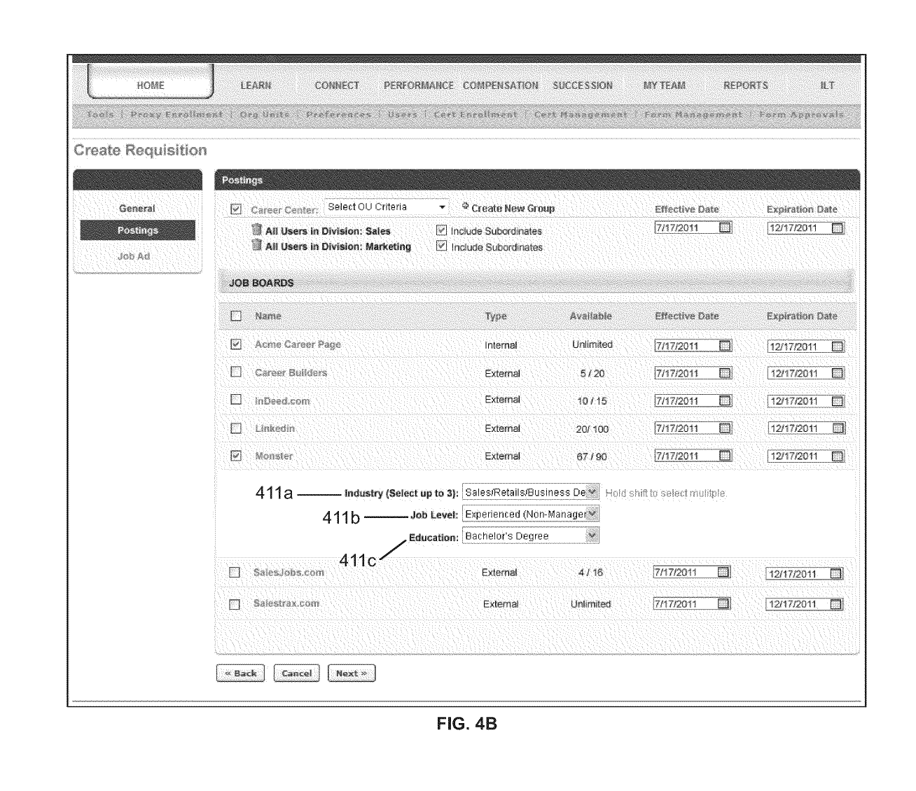

FIG. 4A depicts a screenshot of an example of the invention where the user can manage the posting of job requisitions. First, in one example, a user may check a box to post the Career Center Job description to the Career Center Job Board 401. The user may restrict which groups may access the job posting. Alternatively, the user may select which groups the job posting is advertised too. In examples of the invention where both companies and job-seekers use the requisition and hiring system, this Job Board may be accessible by job-seeker users of the system. It may be broadcasted to users in Sales or Marketing, as shown by the groups listed 402 in the depicted example. In the example shown, the system further provides for the restriction of who within a group has access to the job posting, as shown by the checked boxes 403 choosing to include subordinates.

The embodiment of the invention depicted in FIG. 4A also includes a way to manage external and internal job postings. A list of job boards 403 may be provided. The user may be able to indicate which job boards he or she wishes to post this job requisition to, as shown by the checked boxes 404 in FIG. 4A. For example, different job boards may belong to different entities. For example, different job posting websites may have their own job boards. The system may permit a job description generated within the system to be provided at the different websites. The selection interface may permit the user to provide the job description to the different job boards quickly in a consolidated interface, rather than having to log into separate job boards and post them separately.

Job postings management may occur by pulling posting data onto the system. For instance, job posting information from a plurality of job boards may be pulled and aggregated within the system. The system may permit data management, normalization, and/or display of the pulled posting data.

In some alternative embodiments, the user may also specify which job description goes to which board. In this example, the user has indicated “Internal” 405 for one of the job boards (that of their website), and “External” 406 for other, third party, job boards. Internal and External job boards may be managed separately or together. As discussed, examples of the invention include the ability to add additional job boards to this list. The user may further customize each listing with an “Effective Date” 407 and an “Expiration Date” 408. The Effective Date 407 may instruct the system to not transmit the job opening and description to the website until that date. Alternatively, the Effective Date may tell potential employees when the firm is looking to fill the job opening. The “Expiration Date” 408 may result in the system automatically contacting the account of the user on the external job boards and removing the job listings. Alternatively, it may result in the job posting being modified to include language clarifying that the job opening has expired. In some examples, the job board websites have ways to include these dates in their listings and/or automatically post and remove requisitions, and the dates entered into the system here 407-408 are passed on to the external job board.

In some instances, the various job boards may have a limited number of postings available. Alternatively, the number of postings for a job board may be unlimited. The user interface may have one or more posting number indicator 410, which may indicate how many job postings are left per job board. For example, one or more job boards, such as an internal job board may have an unlimited number of available posting spots left. Another job board may have 5/20 posting spots left. Another job board may have 20/100 job board spots left. This may be useful for a user in gauging whether to select a particular job board for a job posting. For example, if fewer job posting spaces are left for a particular job board, the user may be more selective about which job postings to include. The user may also want to tailor likely candidates at particular job sites with job descriptions to those sites.

FIG. 4A depicts an example of the current invention where the user may post one or more job descriptions to a plurality of internal and/or external job boards with a single button click 409. The user may be able to post one or more job descriptions to a plurality of internal and/or external job boards simultaneously without having to re-enter the job descriptions multiple times.

FIG. 4B provides an additional view of job posting requisition page. In some instances, additional details may be displayed for one or more job board. In some embodiments, selecting a particular job board may cause an additional view to be provided. A view of a job board may be expanded and/or collapsed. In some embodiments, an expanded view may include an interface that may permit a user to provide additional details about the job posted at the job board.

For example, a user may be able to select one or more industry 411a, job level 411b, and/or level of education 411c. In some instances, a user may be able to select one or more, two or more, three or more, four or more industries, job levels, and/or education levels. In some instances, the details may be selected from drop down lists, clicked selections, buttons, entered as text fields, or any other user interface tool.

In some embodiments, all of the job board views may be expanded and/or collapsed together. Alternatively, individual job boards may be selected to be expanded to show additional details and/or collapsed to hide details.

The additional details (e.g., job details) may be specific to individual job boards to which they apply. For example, if a level of education is specified for a particular job board (e.g., specifying Bachelor's Degree for Monster), it may apply only to that particular job board (e.g., Monster). Alternatively, additional details may be applied universally to all job boards (e.g., specifying a Bachelor's Degree may apply to all job boards).

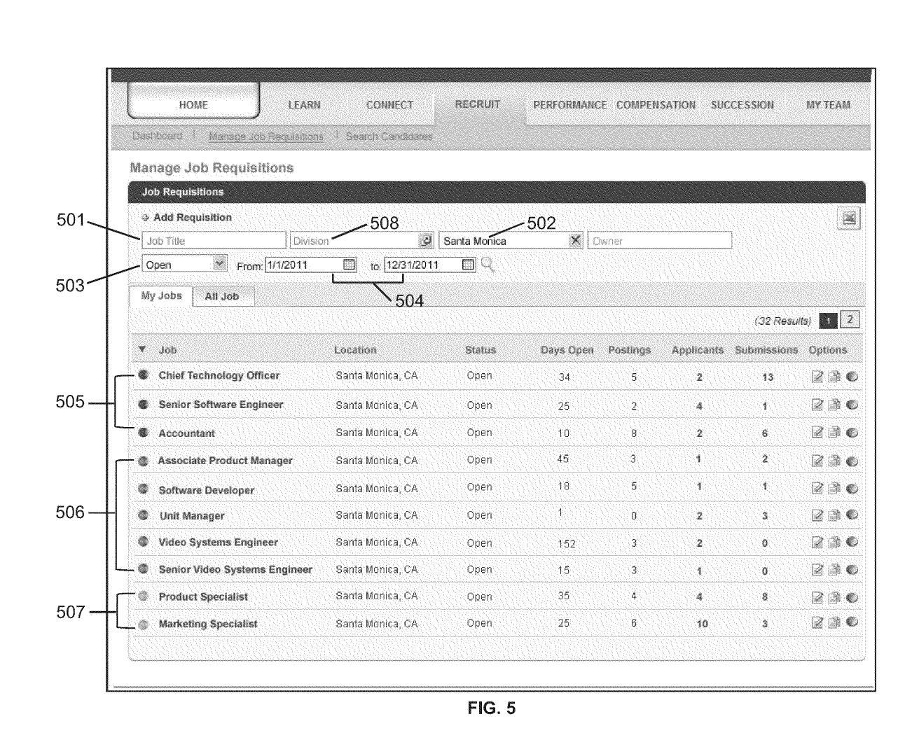

In FIG. 5, an embodiment of the invention wherein a user can manage multiple job requisitions is depicted. FIG. 5 shows an example of a graphical user interface where the user may conduct a search 501 of the available job requisitions. The search may be narrowed by one or more parameter. For example, a search may be conducted for job requisitions at a location 502, of a group/division 508, of a certain status 503, and/or within a certain time period 504. The system may provide a list of the job requisitions matching the search criteria.

The job requisitions in the list may or may not be provided in order based on their matching one or more search criteria. The job requisitions may be ordered based on any other quality. In some examples, the job requisitions are ordered based on some quality, such as importance, days open, number of campaigns, candidates or applicants. In the example depicted in FIG. 5, the importance level of a job requisition is indicated by a circle, which may be red 505, yellow 506 or grey 507. A job with a red circle 505 may have been indicated as an urgent need by the user when the job requisition was created. Other visual indicators of importance or ranking may be provided, including but not limited to different shapes, flags, arrows, highlights, colors, or size.

Summary information for various job requisitions, such as location, status, days open, campaigns, candidates, applications, and additional options may be provided per job requisition. Such summary information may be viewable within a user interface. This may enable a user to view the summary information at once for a particular job requisition and make quick assessments on the state of various job requisitions.

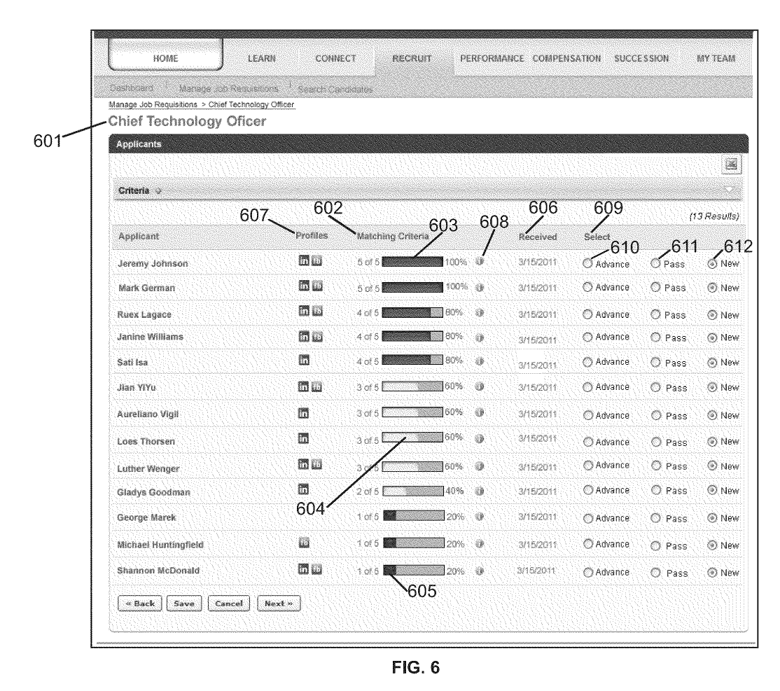

FIG. 6 displays a screenshot having a list of candidates for a specific job 601. The user may use this user interface to manage the candidates for a position. The candidates may be ranked based on their matching criteria 602. The matching criteria may use a list of criteria provided by the user to give a percentage match or score of the candidate. In some examples, the user may weigh the importance of certain criteria, and if a candidate has a more important feature they receive a higher ranking. In the example depicted in FIG. 6, different colors are employed to sort the candidates based on their matching criteria. The matching criteria may be based on one or more quantitative or qualitative evaluation of the candidate. The matching criteria may or may not take into account feedback from one or more interviewer or contact of the candidate.

The candidate's results based on matching criteria may be visually depicted. For example, the candidates with more than a certain threshold, in this example 80%, may receive a green color 603. Candidates with a middle threshold, in this example 40%-60%, may receive a yellow color 604. Candidates below a certain threshold, in this example 20%, may receive a red color 605. Two, three, four, five or more colors may be used to sort the candidates. In some examples, each color receives an equal percentage interval, in other examples, there may be larger intervals for certain colors. The user may specify colors and intervals to personalize the candidate list. For example, the intervals may be a score out of three, four, five, ten, twenty, fifty, one hundred, or any other numeric value, and/or may be provided as a percentage. The results may also be depicted in a pictorial fashion. For example, a bar with one or more colored or shaded portion may be used to indicate the degree of matching. Similarly, one or more stars, balls, or other shapes may be provided to indicate the degree of matching.

The candidate's results based on matching criteria may be visually matched to the respective candidate. For example, a candidate's matching criteria results may be in the same row or column as the candidate's name or other identifier. The candidate's matching criteria results may be adjacent to the candidate's name. Additional information associated with a candidate may also be displayed. The additional information also be visually mapped to the candidate name, e.g., within the same row or column as the candidate's name.

The list of candidates for a job requisition may also include the day the application was received 606, what social network connections the user has access to 607, a link to receive more information about the candidate 608 and/or other information about the candidates. In some examples, clicking or selecting one or more profiles of the candidate based on a social network link 607, may open the candidate's profile within that social network. For example, a candidate may have both a LinkedIn and Facebook profile. Selecting the LinkedIn link may cause the candidate's LinkedIn profile to be visible. Selecting the Facebook link may cause the candidate's Facebook profile to be visible.

The user may also select how to proceed with each candidate 609. In some examples, there are three options, in others there may be two, or four or more. In one example, the user may “Advance” 610 the applicant to the next level, “Pass” 611 and save the application for later or send the applicant a rejection, or “New” 612, which may correspond with new applicants who need to interview, or from whom more information is required, before a choice between “Advance” 610 and “Pass” 611 is made. In other embodiments, any number of selection options may be provided, with corresponding to different actions that can be taken for candidates which may include multiple stages of requisition, interviewing, or alternate interviewing paths. This is one example of the choices a user may have in managing job requisition applicants, in other examples a different set of options is used, or the options shown in FIG. 6 correspond to a different action with respect to the applicant.

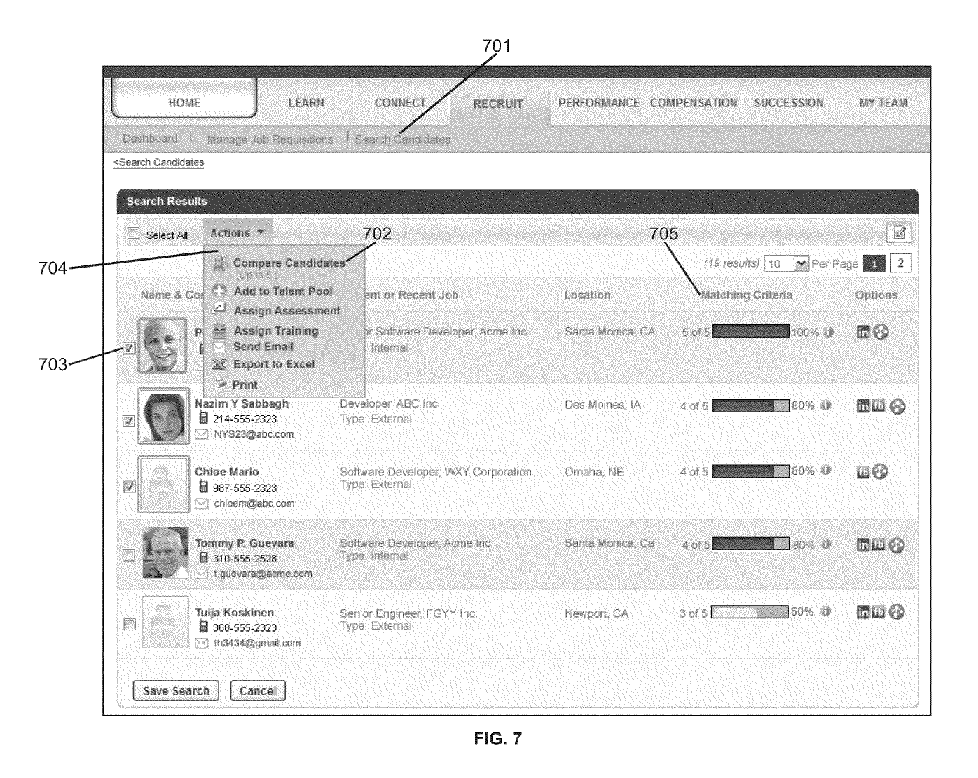

FIG. 7 depicts an aspect of an embodiment of the invention wherein a screenshot of the results of a candidate search is shown. In this example, the user may “Search Candidates” 701. The user may choose to compare candidates applying for the same job requisition 702. In some examples, the user may use search criteria other than the job requisition to search for candidates, for example the user may search by location, previous job or experience level. The user may search within internal candidates who are already employees, external candidates outside the company, or both. In some embodiments of the invention, the user specifies the important criteria for a specific job requisition and the system performs a search of all applicants to all job requisitions for the candidates with the highest matching percentages or scores. Thus, the system may discover the best candidates for a job requisition irrespective of whether the candidate applied for that specific posting, and allow the user to automatically identify and contact the best matches for the requisition.

In some embodiments, matching criteria 705 may be displayed. As previously discussed, matching criteria may be visually depicted with one or more color for different thresholds, or other visual indicators of thresholds that reflect degree of matching.

FIG. 7 further depicts an interface which allows the user to select one, two or more candidates with a check-box 703, and perform an action on the group. FIG. 7 shows an aspect of the invention comprising a drop down menu of action choices for the candidates selected 704. The user may compare the candidates with one another, add to a reservoir of potential candidates kept by the system (the “Talent Pool”), assign assessment, assign training, send email, export to excel and/or print. In other examples of the invention, the user may select a group of candidates and check, using their social network connections and those of the company's current employees, whether the candidates have either a connection with a current employee or connections in common with a current employee. The user may then use the results of the search to contact employees to get more information about the prospective candidates.

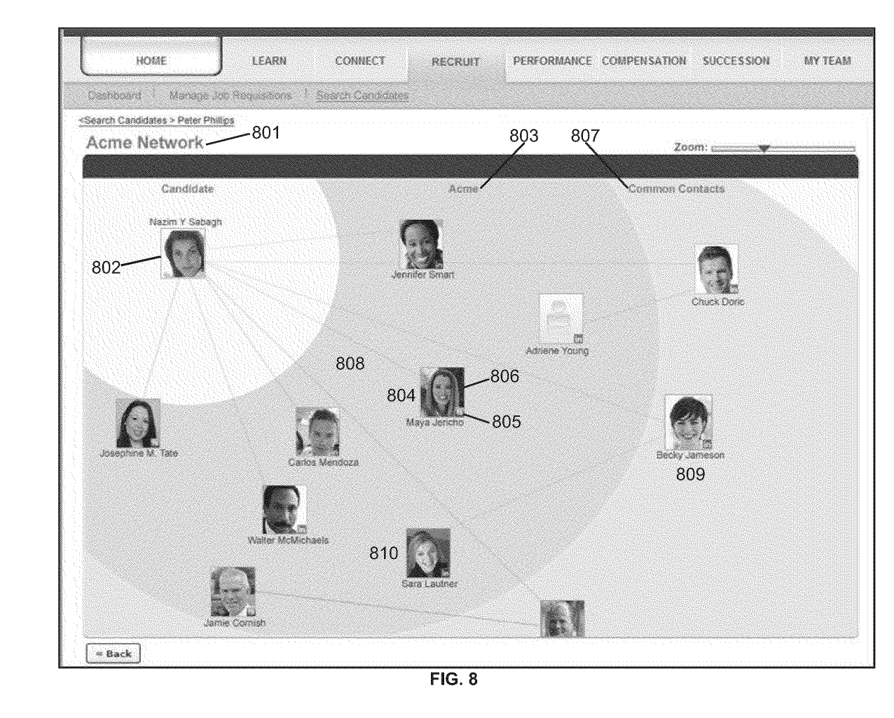

An aspect of an embodiment of the invention is depicted in FIG. 8, showing the integration of candidate and employee social networks. In some examples, the user can pull the Company Network 801 for any candidate 802 who has agreed to let the user access his or her connections on social networks. The candidate 802 may have connections with employees within the company sphere 803. In some examples, the system will automatically contact these employees for a recommendation on how to proceed with this candidate, or to gain additional information concerning this candidate. In other examples, the user may click or select in any other manner, one or more of the employees who have a connection 804 with the candidate, and a separate screen or process may allow the user to contact the chosen employees. The user may be able to simultaneously select a single employee, a group of employees, or all employees who have a connection with the candidate. The system may also allow the user to use a pre-generated message or compose a message and send it to one or more employees. In some examples, the social network used to find the connection 805 is shown along with a picture of the employee connection 806.

The example depicted in FIG. 8 further comprises a “Common Contacts” sphere 807. In some examples of the invention, the system uses the social networks to find individuals who are connected to both the candidate and a current employee. In the example shown in FIG. 8, connections are shown with lines 808. Such connections may be between any two individuals. For example, such connections may be between a candidate and an employee, between a candidate and common contact, or between an employee and a common contact. The networks may be depicted in a web or tree fashion or individuals are the nodes of a web, which may be connected by lines showing relationships/connections between individuals. In other examples, the company and common contacts may be in list or column format, or presented to the user grouped by network, or a different way. The system may identify the connections with pictures 806. The system may also provide a textual representation of the spheres.

In some embodiments, pictorial representations may be provided for different spheres. For example, a company sphere 803 and a common contacts sphere 807 may be visually distinguishable from one another. For example they may be provided in different regions of the user interface, have different colors or shading, have outlines or other visually distinguishing features. In one example, a candidate may have a candidate sphere, the company sphere may be at least partially surrounding or close to the candidate sphere, and/or the common contacts sphere may be at least partially surrounding the company sphere or may be further from the candidate sphere than the company sphere. Any number of spheres may be provided including one, two, three, four, five, six or more spheres. The various spheres may represent one or more groupings of contacts of a candidate. The groupings of candidate contacts may indicate zero, one, two, three, four, five, or more degrees of separation from the company and/or candidate, or between the company and/or candidate. In some embodiments, spheres that are closer (have fewer degrees of separation) between the candidate and/or company may be displayed closer to the candidate profile.

In some embodiments, a candidate's contacts 804, 809 may be displayed in the proximity of a candidate's profile 802. In some embodiments, the candidates' contacts may be displayed closer to the candidate's profile if the candidates' contacts fall within a company sphere or other grouping that may be displayed closer to the candidate profile or be selected as being highly relevant to the job requisition process. For example, a candidate's contact within the company 804 may be displayed closer to the candidate's profile than a candidate's contact who is a common contact outside the company 809. In some embodiments, if a candidate's contact appears in multiple settings (e.g., through multiple social networking sites, contact lists, and/or are identified by the candidate), then it may be inferred that the candidate knows the contact better. Such contacts may or may not be displayed closer to the candidate contact.

In some embodiments, the number and/or types of spheres to be displayed may be fixed. Alternatively, a user may specify the desired number of spheres and/or degrees of separations of contacts to be displayed. For example, a user may select an option to display only a candidate and connections that the candidate has within the company. The user may select an option to display a candidate, connections the candidate has directly within the company, and common contacts that the candidate and one or more employee of the company have. A user may also select an option to display a candidate, the connections the candidate has directly within the company, common contacts that a candidate and one or more employee of the company have, and another degree of separation of contacts that the candidate, employee of the company and/or common contacts have, or any additional degrees of separation.

The “Common Contacts” sphere 807 allows the user to request an employee get a personal opinion of, recommendation for/against or other information about the applicant. The employer may click a current employee 810 and compose a message on the system to ask their outside contact 809 for a recommendation for or against or other information about the candidate 802. Alternatively, such a message may be automatically generated and/or sent to current employees that may share an outside contact with the candidate. The system may provide a form for this correspondence. The message, or form, may be customizable. The system may also provide the employee with log-in information to provide the feedback they obtain to the system. If current employees use the system, their account may be edited to have access to this candidate's profile, in order to provide information or feedback concerning the candidate on the candidate's file or profile.

In some embodiments, clicking on a candidate profile may display information about the candidate (e.g., name, location, contact information, position applying for, social networks). Clicking on a candidate profile may provide an option for sending a correspondence to the candidate. Clicking on an employee profile may display information about the employee (e.g., name, location, contact information, position within the company, social networks). Clicking on the employee profile may also provide an option for sending a correspondence to the employee regarding the candidate, as described elsewhere herein. Clicking on the employee profile and/or connecting line between the candidate and employee may provide optional details on the nature of the relationship between the candidate and the employee. The nature of the relationship may be self-identified by the candidate, employee, or may be inferred based on information provided on a social networking site. For example, a social networking site may enable a candidate to designate the types of relationships (e.g., friends, family, co-workers, classmates), and such information may be transferrable to candidate network. Similarly, clicking on a common contact profile may provide information about the common contact (e.g., name, location, contact information, position, social networks). Options may or may not be provided that may permit direct correspondence to the common contact. Clicking on the common contact and/or connecting lines between the candidate and common contact, or between the employee and common contact may optionally provide details on the nature of the relationship between the candidate and common contact or between the employee and common contact.

Clicking on a profile (e.g., employee or common contacts profile), hovering a pointer over the profile, or otherwise selecting the profile may highlight or otherwise visually emphasize the profile. In some embodiments, the profile's connection to the candidate, or other connections of the profile may be highlighted. For example, selecting an employee who is directly connected to the candidate may cause the connection between the employee and the candidate to be highlighted or otherwise visually emphasized. Selecting a common contact may cause the common contact's connection to the candidate and/or the common contact's connection to one or more employee of the company to be visually emphasized. Selecting an employee who is not directly connected to the candidate may cause the employee's connection to a common contact and/or the common contact's connection to the candidate to be visually emphasized. Selecting an individual who is not directly connected to the candidate may cause a path from the selected individual to the candidate and/or a path from the selected individual to an employee of the company to be visually emphasized. In some instances, all paths from the selected individual to the candidate and/or employee of the company may be emphasized. In other instances, the shortest path or any other criteria may be provided to determine which path is emphasized from the individual to the candidate and/or employee.

One or more visual controls may be provided for a candidate network. For example, a zoom tool may permit a user to zoom in or out. Additionally one or more panning tools may be provided. A user may or may not be able to manipulate the location of contacts on the user interface. For example, a user may be able to click and drag the location of a profile. The connections may automatically be readjusted with a repositioning of a profile.

The Candidate Network 801 may integrate one or multiple social networks to allow the user to use the connections of employees in hiring management. In some examples of invention, the candidates can access a similar integration when applying for a job. The candidate may be able to see his or her current connections with a company in the same way a company user may see connections between employees and applicants. Further, the invention may also allow a candidate to see common connections. In some examples of the invention, the system may allow the candidate to directly message current employee contacts or common contacts to ask for information relating to their job search. From these connections, a candidate may receive feedback about the job they are applying for, and solicit a recommendation through a possibly otherwise unknown connection. There may be a “Get Introduction” prompt when a candidate 802 clicks on a current employee connection. Alternatively, the candidate may not be able to access the network integration.

In some embodiments, one or more employees of a company may elect to give the company access to the employee's social networks and/or contact lists. The employee may be able to select which social networks and/or contact lists the company may be able to access. The employee may be able to select which contacts within the social networks and/or contact lists to provide to the company. Alternatively, the company may automatically get all contacts within the social networks and/or contact lists. Alternatively, the employee may be able to self-identify specific contacts that the employee has. For example, the employee may be able to build a contact list and/or social network list for recruiting purposes. The company may be able to import the employee's contacts from the employee's social networks and/or work contact lists (e.g., Outlook address book, mobile device address book, work email address book). The company may be able to import the employee's contacts from external sites (e.g., third party social networking sites) and/or from internal sites (e.g., intranet sites, work emails and/or contacts). The company may be able to access company records to additionally identify contacts of employees. For example, the company may be able to access a company client list and determine which employees personally worked with the clients.

Similarly, one or more candidate for a job at the company may elect to give the company access to the candidate's social networks and/or contact lists. The candidate may be able to select which social networks and/or contact lists the company may be able to access. The candidate may be able to select which contacts within the social networks and/or contact lists to provide to the company. Alternatively, the company may automatically get all contacts within the social networks and/or contact lists. Alternatively, the candidate may be able to self-identify specific contacts that the candidate has. For example, the candidate may be able to build a contact list and/or social network list for job application purposes. The company may be able to import the candidate's contacts from the candidate's social networks and/or other contact lists (e.g., Outlook address book, mobile device address book, work email address book). The company may be able to import the candidate's contacts from external sites (e.g., third party social networking sites).

One or more user interface screen and/or display may be provided where the accessible networks are shown. For example, an employee or candidate may give access to one or more social networks, from which information may be pulled. In some embodiments, one or more public social network may be accessible without requiring employee or candidate permission. In one example, one or more social network may be guaranteed, while others may require access to be granted from the employee or candidate (e.g., LinkedIn may be accessible, while Facebook may require access to be granted). In another example, internal company records and/or company contact lists for employees may be automatically accessible while one or more external social network may require permission from the employee or candidate.

Thus contacts of candidates and/or employees may be gathered. Such contacts may be stored in memory and may be accessible for generating networks. Records of such candidate contacts may be stored for each candidate. Records of employee contacts may be stored on a per employee basis or may be stored as an overall company network pool.

Friend/contact lists gathered from candidates may be pulled and compiled with current employees to find one or more overlap. Overlaps may be provided between the candidates' contact lists and employee names. Additionally, overlaps may be provided between the candidates' contact lists and contacts of employees. Additional degrees of separation may provide bases for overlap.

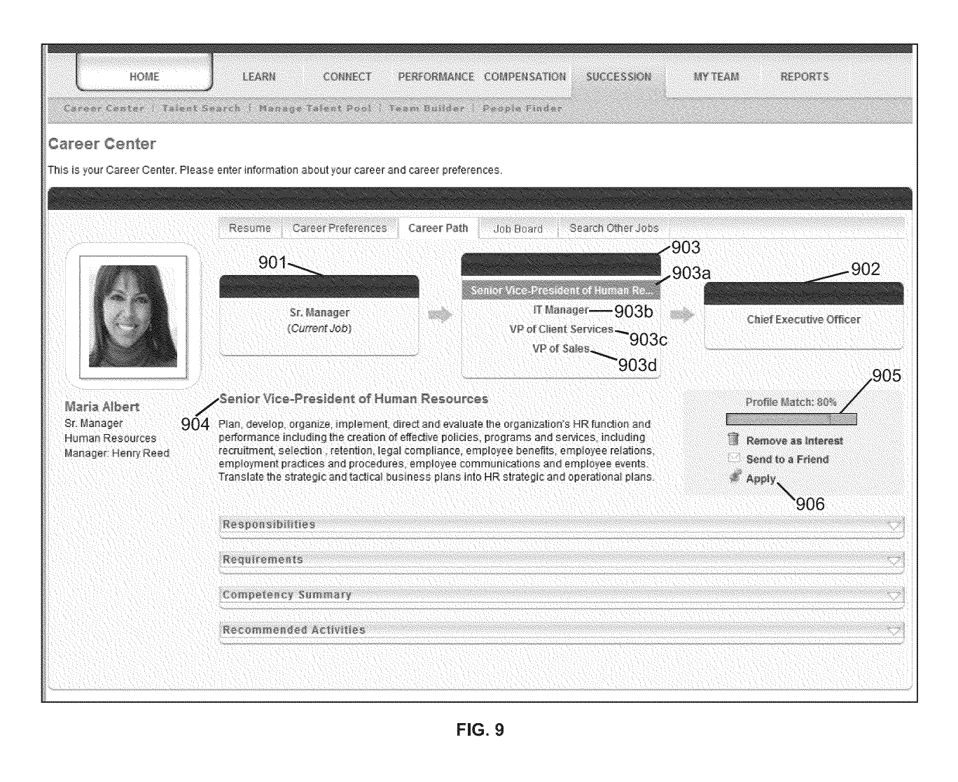

FIG. 9 illustrates an example of an internal employee management interface. An internal employee management interface may display information relating to an internal employee of the company. A career center for an internal employee may be accessible to the employee himself or herself. Alternatively, the career center may be accessible by a human resources employee. The views provided to the employee when viewing the employee's own profile versus the views provided to a human resources employee may or may not be the same. An employee may be able to view his or her own resume, career preferences, career path, job board, and/or may be able to search other jobs.

An employee may be able to view and/or set the employee's career path. A career path interface may display the employee's current position 901. The career path interface may display the employee's target future position 902. One or more intermediary positions 903 between the current position and the target position may be displayed. In some embodiments, only one step may be provided between the current position and the target position. Alternatively, there may be no steps between the current position and target position, two steps between the current position and target position, or three or more steps between the current position and target position. The steps may be provided as a progression between the current position and the target position. There may also be alternative paths 903a, 903b, 903c, 903d between the current position and the target position. The alternative paths may be provided for one or more step. The alternative paths may or may not be displayed simultaneously.

The career path may or may not optionally display the past positions held by the employee. For example, the career path may include the first position held by the employee and the intermediate steps from the first position to the current position.

The employee's target future position 902 may be selected by the employee. Alternatively, a default target position may be provided. In some embodiments, the default target position may be the highest position in the company.

The intermediate positions may or may not be generated by the system. Given a designated target position, and the employee's current position, the system may be able to determine likely intermediate positions. Alternatively, the employee may enter and/or select the intermediate positions.

A career path may be displayed in a visually mapped arrangement. For example, a linear arrangement may be provided with a current position 901 at one end and a target position 902 at the other end. One or more intermediate steps 903 may be displayed between the current and target position. One or more alternate positions for a particular intermediate step may be displayed at that intermediate step displayed between the current and target position. One or more pointer, such an arrow, may indicate the flow of the career path. The career path may be displayed in a horizontal linear arrangement, a vertical linear arrangement, or may have any other orientation.

In one example, an employee's current job may be a senior manager of human resources. The employee may designate their target position as CEO. Intermediate positions may be provided, which may permit the employee to select from senior VP of human resources, IT manager, VP of client services, or VP of sales.

An employee may be able to select one or more of the intermediate positions 903a. Details about the selected intermediate position 904 may be displayed. Such details may include a description of the position, responsibilities for the position, requirements for the position, a competency summary, and recommended activities.

In some embodiments, a profile match 905 for the selected intermediate position may also be provided. The profile match may indicate how closely a selected intermediate position matches criteria related to the employee's current position and/or target position. A profile match may include one or more visual indicator of how closely a selected position matches. Such visual indicators may include but are not limited to one or more color, numerical value, pictorial display, and/or other matching displays described elsewhere herein.

One or more of the alternative paths provided may have differing or the same profile match as the others. For example, some intermediate paths may be better suited for an individual of the employee's background and/or experience than others. Similarly, some intermediate paths may be better suited for particular target positions than others. In some embodiments, the target position and/or intermediate positions may be selected from job openings. Otherwise, they may indicate positions within the company regardless of whether there is currently a job opening for such positions or not. In some embodiments, the alternate paths may be displayed in order from having the highest profile match to the lowest profile match. For example, at an intermediate step 903, one or more alternative paths 903a, 903b, 903c, 903d may be provided, where the first displayed alternative path 903a may have the highest profile match and the last displayed alternative path 903d may have the lowest profile match. Alternatively the alternative paths may be displayed without any regard to ranking or match.

The employee may be able to access an internal job board from the career path interface. In some embodiments, a user may be able to select a position, and select a link or option 906 to apply for the selected position. The user may also optionally remove the position or send the position to a friend.

In some embodiments, career path projections may be used in conjunction with recruiting. For example, a projected career path for a candidate may be mapped out. The candidate may be applying for a job opening. The job opening may be a current career position for which the candidate is being considered.

In one example, a method for displaying one or more career path may comprise: determining, using a processor, a current career position for which a candidate is being considered; determining, using a processor, one or more subsequent career positions within the company following the current career position in an expected career path; and displaying, on a display device, the current career position and the one or more subsequent career positions in the expected career path. The expected career path may or may not end in a target career position, selected by the candidate, selected by an employee of the company, and/or suggested by the system.

The current career position and one or more subsequent career positions in the expected career path may be displayed in a visually mapped manner. For example, the current career position and the one or more subsequent career positions may be displayed adjacent to one another. They may be displayed in the order they are likely to occur. One or more arrow or pointer may indicate a likely flow of career positions in the path. In one example, a current career position (e.g., for which a candidate is being considered) may be displayed on a left side, with an arrow pointing to a subsequent career position that is likely to follow the current career position, with an arrow pointing to another subsequent career position that is likely to follow the first subsequent career position. The career path may be displayed as a row, column, or may have any other linear orientation. If alternative expected career paths are provided, they may be displayed parallel to one another, or may have any other orientation with respect to one another.

The career path starting with the current career position may include one or more subsequent positions that may be expected along the career path. The required criteria, such as required competencies, training, certifications, qualifications, and/or experience for the subsequent positions along the expected career paths may be considered. In some embodiments, the required criteria for the subsequent positions may be displayed. In some embodiments, a subsequent position may be selected based on whether the candidate meets the required criteria for the subsequent position, or whether the candidate may be expected to meet the required criteria at the time the candidate would be considered for the subsequent position. For example, if the candidate is expected to be up for a promotion to a subsequent position in three years, it may be considered whether the candidate will have accumulated the requisite experience or trainings by that time.

In some embodiments, the required criteria may be considered by a company when evaluating a candidate for the current career position. The required criteria for the subsequent positions may be considered when evaluating whether the candidate would have a long successful career within the company. In another embodiment, the required criteria may be considered by a candidate who may be applying for the current career position. The candidate may review the expected career path(s) and may consider what skills the candidate would need to obtain, or that the candidate already has, and whether the expected career paths would fit with the candidate's long term goals.

In some instances, for a current career position, one expected career path may be displayed. Alternatively, multiple expected career paths may be provided. A user, who may be an employee of the company, or a candidate, may be able to select one or more of the expected career paths. In some instances, details, such as the required criteria may be simultaneously displayed for all expected career paths. Alternatively, selecting a career path may provide additional details related to the selected career path, such as required criteria for one or more of the career positions provided in the selected career path.

In some embodiments, the subsequent career positions for an expected career path may be included based on current openings or projected openings within the company. For example, if a VP of sales is likely to retire within the next few years, that position may be projected to become open in several years, which may be when a candidate's career path may lead in that direction. In another example, a company may be planning on growing a particular group, so new positions may be created which may be considered in the candidate's expected career path. Alternatively, any career position may be included in expected career paths, regardless of whether of current or projected availability.

The expected career path for an individual may be dynamically generated and/or updated. The career path may be generated and/or updated based on current or projected available career positions, the individual's current experience and whether the individual meets or is projected to meet required criteria for the subsequent positions, and/or whether the individual has expressed in interest in certain career paths over others.

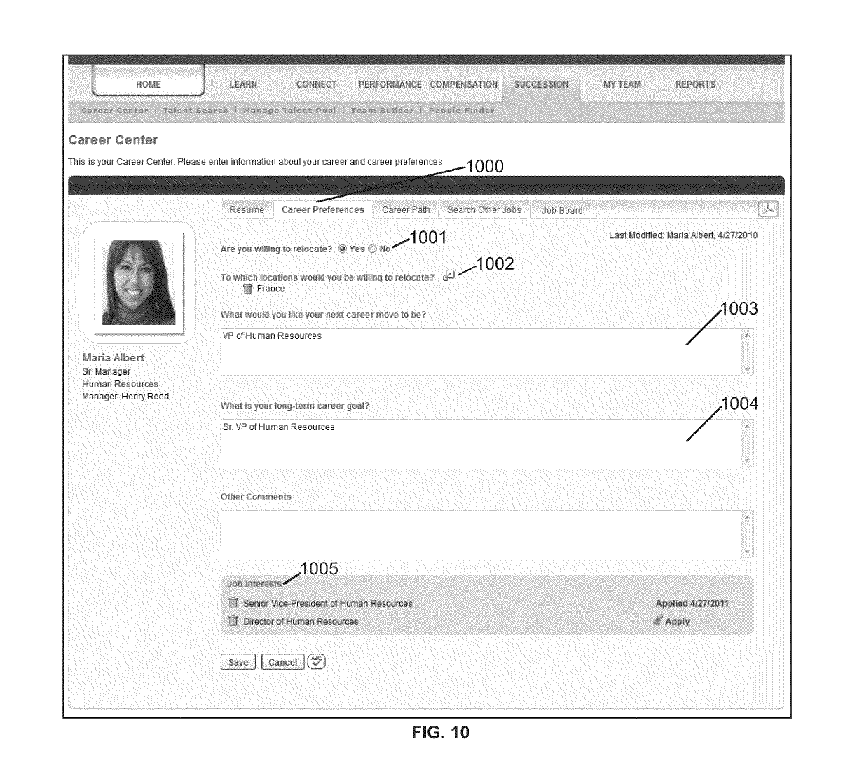

FIG. 10 shows an interface for managing career preferences 1000. The career preferences may or may not be useful for determining career path. The career preferences may assist an employee with managing potential future positions for the employee.

The career preferences interface may include an option for the employee to indicate whether the employee would be willing to relocate 1001, and if so, where the employee would be willing to relocate to 1002.

The employee may also be able to indicate a desired next career move 1003 and/or a long-term career goal 1004. One or more additional comments may be provided. The desired career move or long-term goal may be entered directly by the employee. Alternatively, the employee may be able to select positions from a career path interface, which may store the career move and/or long-term goal in the career preference interface. Alternatively, entering desired career moves and/or long-terms goals in the career preference interface may determine the career path that may be generated in the career path interface.

The career preference interface may also include a job interests section 1005. Job interests section may include positions within the company that may match or be closely related to desired next career moves and/or long-term career goals. The positions in the job interests sections may include one or more positions that may appear on a career path interface. The positions in the job interests section may include one or more job openings that the employee has viewed. The job interests may list the positions, as well as indicating whether the employee has applied for the position and/or providing a link for the employee to apply.

In some embodiments, the career preferences page may be viewable only to the employee. The employee may use it internally to manage the employee's career goals. Alternatively, the career preferences page or at least some of the information gathered on the career preferences page may be accessible by a human resources employee of the company. For example, the human resources department may keep an eye out for employees that may be useful to fill a particular job opening. The career preferences of the employees may be taken into account when the human resources consider contacting one or more employee for a job opening.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of embodiments of the invention herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A requisition and hiring system comprising:
a processor capable of accessing records of one or more contacts of a candidate for a position within a company, wherein the processor is capable of accessing contacts for one or more employees of the company, wherein the processor is further capable of comparing the records of the one or more contacts of the candidate with the contacts for the one or more employees; and
a display device showing via a website, one or more contacts of the candidate that is an employee of the company or that is a common contact with an employee of the company, and connections therebetween, based on said comparison,
wherein the processor is configured to access one or more social network of the candidate to access records of the one or more contacts of the candidate.

2. The system of claim 1 wherein the display device shows the one or more contacts to the candidate.

3. The system of claim 1 wherein the display device shows the one or more contacts to a user.

4. The system of claim 1 wherein the display device shows a user interface requesting the candidate's permission to access the one or more social network of the candidate.

5. The system of claim 3 wherein the display device presents the user with an option of requesting one or more recommendations from the one or more contacts of the candidate that is the employee or the common contact of the employee.

6. The system of claim 1 wherein the processor is configured to automatically request one or more recommendations from one or more contacts of the candidate that is the employee or the common contact of the employee without requiring user intervention.

7. The system of claim 1 wherein the processor is configured to access one or more social network of the employee of the company.

8. The system of claim 1 wherein the display device shows a pictorial representation with one or more lines between a visual representation of the candidate and a visual representation of the employee or the common contact of the employee.

9. The system of claim 8 wherein the pictorial representation further comprises a company sphere with the company employees visually mapped to the company sphere.

10. The system of claim 9 wherein the pictorial representation further comprises a common contacts sphere visually distinguishable from the company sphere with the common contacts of the employee visually mapped to the common contacts sphere.

11. A method for requisition and hiring comprising:
accessing, with aid of a programmable processor, records of one or more contacts of a candidate for a position within a company,
accessing, using the processor, contacts for one or more employees of the company by accessing one or more social network of the candidate;
comparing, with aid of the processor, the records of the one or more contacts of the candidate with the contacts for the one or more employees; and
showing, via a website on a display device, one or more contacts of the candidate that is an employee of the company or that is a common contact with an employee of the company, and connections therebetween, based on said comparison.

12. The method of claim 11 further comprising requesting the candidate's permission to access the one or more social networks of the candidate.

13. The method of claim 11 wherein presenting a user with an option of requesting one or more recommendations from the one or more contacts of that candidate that is the employee or the common contact of the employee.

14. The method of claim 11 further comprising automatically requesting, with aid of a processor, one or more recommendations from one or more contacts of the candidate that is the employee or the common contact of the employee.

15. The method of claim 11 further comprising accessing, with aid of the processor, one or more social network of the employee of the company.

16. The method of claim 11 further comprising receiving, from the candidate, self-identified connections with the employee or the common contact of the employee.

17. The method of claim 11 further comprising displaying a pictorial representation with one or more lines between a visual representation of the candidate and a visual representation of the employee or the common contact of the employee.

18. The method of claim 17 wherein the pictorial representation shows the visual representations of the candidate's contacts displayed closer to the visual representation of the candidate if the contacts fall within a company sphere than if the contacts fall outside the company sphere.

19. The method of claim 18 further comprising inferring the closeness of a contact with the candidate based on the frequency of the contact appears in multiple social networks, and displaying closer candidates in closer proximity to the visual representation of the candidate.

20. The method of claim 17 further comprising receiving from a user a desired degree of separation, and displaying the visual representation of the candidate connected with visual representations of one or more of the candidate's contacts that fall within the received degree of separation.

21. A method for displaying one or more career path comprising:
determining, using a processor, a current career position for which a candidate is being considered;
determining, using a processor, one or more subsequent career positions within the company following the current career position in an expected career path; and
displaying, on a display device, the current career position and the one or more subsequent career positions in the expected career path.

22. The method of claim 21 further comprising receiving, from the candidate, a target future position.

23. The method of claim 22 wherein the expected career path is generated with aid of a processor based on the target future position.

24. The method of claim 23, wherein the expected career path includes one or more intermediate positions generated with aid of a processor.

25. The method of claim 22, further comprising displaying one or more alternative career path resulting in the same target future position.

26. The method of claim 21 wherein the career path is displayed as a linear arrangement.
